(19) United States
(12) Patent Application Publication
(10) Pub. No.: US 2026/0318251 A1
(43) Pub. Date: Oct. 15, 2026

(54) TURBINE ENGINE COMPRISING AN ACCESSORY DRIVE, A LUBRICATION UNIT AND AN OIL TANK

(71) Applicant: SAFRAN AIRCRAFT ENGINES, Paris (FR)

(72) Inventors: Valentin Sebastien Simon AVOYNE, Moissy-Cramayel (FR); Bruno Albert BEUTIN, Moissy-Cramayel (FR); Bertrand Romain Adrien DUFOUR, Moissy-Cramayel (FR)

(21) Appl. No.: 19/483,568

(22) PCT Filed: May 15, 2024
(86) PCT No.: PCT/FR2024/050618

§ 371 Date: Nov. 11, 2025

(30) Foreign Application Priority Data
May 25, 2023 (FR) 2305223

(51) Int. Cl. F02C 7/32; F02C 7/06

(52) U.S. Cl. CPC F02C 7/32; F02C 7/06; F05D 2260/4031; F05D 2260/98

(57) ABSTRACT

A turbine engine including a casing an accessory drive suspended from, and connected to, the casing including a housing, which defines an internal cavity, and a gear train arranged in the internal cavity; a lubrication unit including an equipment housing fixed and attached to the housing,at least one pump located in the equipment housing, which includes a rotor coupled to the gear train, and an oil inlet connected to the pump; and an oil tank including an oil outlet connected to the oil inlet of the lubrication unit, wherein the tank is directly attached to the equipment housing and is placed above the lubrication unit so that the oil flows into the lubrication unit under the effect of gravity.

### TECHNICAL FIELD OF THE INVENTION

The invention relates to the field of the aircraft turbine engines. The invention relates in particular to the field of turbine engines comprising an accessory gearbox, a lubrication unit and an oil tank.

### TECHNICAL BACKGROUND

The prior art is illustrated by the documents US-A1-2012/0159966 and US-A1-2018/0195413.

An aircraft turbine engine generally extends along and around a longitudinal axis. From upstream to downstream, in the direction of gas flow in the turbine engine, it comprises a fan, a low-pressure compressor, a high-pressure compressor, a gas combustion chamber, a high-pressure turbine and a low-pressure turbine.

The turbine engine typically comprises an engine compartment delimited radially by engine casings surrounding the compressors, the combustion chamber and the turbines.

In the configurations of turbine engine with a ducted fan, the turbine engine also comprises a fan compartment radially delimited by a fan casing surrounding the fan. In the configurations of turbine engine with a non-ducted fan, the turbine engine does not comprise a fan casing and therefore no fan compartment.

In addition, the rotor of the low-pressure compressor is typically connected to the rotor of the low-pressure turbine by means of a low-pressure shaft. The rotor of the high-pressure compressor is connected to the rotor of the high-pressure turbine by a high-pressure shaft. The shafts are guided in rotation by means of guide bearings, which need to be lubricated to ensure that they operate correctly.

It is therefore known to spray lubricating oil onto the guide bearings. In order to protect the associated members of the turbine engine from this lubricating oil, the guide bearings are typically arranged in lubrication enclosures.

In order to lubricate the bearings in the lubrication enclosures, the turbine engine typically comprises an oil circuit. The oil circuit is typically a closed circuit comprising a bearing lubrication circuit and possibly an oil recovery circuit from the lubrication enclosures. The oil circuit typically comprises a lubrication unit connected to an oil tank by oil inlet pipes and possibly oil return pipes. The lubrication unit comprises at least one supply pump to suck oil from the tank and distribute it to the lubrication enclosures through the supply circuit. The lubrication unit typically comprises an equipment housing wherein at least one rotor of the supply pump is arranged, and at least one pump oil inlet connected to the tank by the inlet pipe.

In order to drive the rotor of the supply pump for supplying the lubrication unit, the lubrication unit has been known to be fitted and attached to an accessory gearbox, referred to as accessory gearbox (AGB). The accessory gearbox is used to transmit mechanical power from the turbine engine to the accessories of the turbine engine, such as the lubrication unit pump. The accessory gearbox typically comprises a housing comprising an upstream face and a downstream face defining between them an internal cavity wherein is arranged a gear train having a series of pinions meshing with one another. The casing of the lubrication unit is attached to one of the faces of the gearbox and the rotor of the supply pump is coupled in rotation to one of the pinions of the gear train.

In turbine engine configurations with a ducted fan, the tank and the accessory gearbox carrying the lubrication unit are typically located in the fan compartment. The oil tank is attached to the outside of the fan casing, to a first part of the fan casing, while the accessory gearbox carrying the lubrication unit is suspended outside the fan casing at the level of a lower part than the first part to which the oil tank is attached.

However, such a configuration is not suitable for turbine engines with non-ducted fans, which comprise no fan compartment and therefore no fan casing. It was therefore decided to move the oil tank and the accessory gearbox carrying the lubrication unit into the engine compartment, and to attach the oil tank to one of the engine casings and suspend the accessory gearbox from the same engine casing.

However, given the size of the fuel tank and the small diameter of the casing compared to the diameter of the fan casing, it is not easy to arrange both the fuel tank and the accessory gearbox carrying the lubrication unit in the engine compartment. For lubrication needs in all circumstances, particularly in zero gravity (0 g) or negative gravity (negative g) conditions, or when the aircraft is at a high angle of attack, most of the volume of the tank is located in the upper part of the engine compartment, i.e. the upper half extending between 9 o'clock and 3 o'clock in the azimuth position. This gives the tank a high tangential height. However, given the small diameter of the engine casing and the fact that the lower part of the engine compartment is occupied by the accessory gearbox, while the upper part is occupied by the thrust connecting rods, for example, the engine compartment does not have enough space to accommodate such a tank. This space is all the more insufficient as it is necessary to provide a distance between the tank and the lubrication unit to accommodate and mount the inlet pipe connecting the tank to the lubrication unit. This problem is further complicated by the need to ensure the flexibility of the inlet pipe connecting the lubrication unit, which is subject to movements imposed by the accessory gearbox, and the tank, which is rigidly attached to the engine casing due to its overall dimension.

In this context, there is a need to provide a turbine engine comprising an accessory gearbox, a lubrication unit and an oil tank, the overall dimensions of which are reduced to allow and facilitate the integration of this assembly in the turbine engines with both ducted and non-ducted fans.

### SUMMARY OF THE INVENTION

To this end, the invention proposes a turbine engine for an aircraft, the turbine engine having a longitudinal axis and comprising:
an annular casing centered on the longitudinal axis,
an accessory gearbox which is located outside the casing and which is suspended from the casing, the accessory gearbox being connected to the casing and comprising:
a housing defining an internal cavity, and
a gear train arranged in the internal cavity,
a lubrication unit comprising:
an equipment housing fitted and attached to the housing of the accessory gearbox,
at least one pump located in the equipment housing and comprising a rotor coupled to the gear train, and
an oil inlet connected to the pump, and
an oil tank comprising an oil outlet connected to the oil inlet of the lubrication unit.

The turbine engine is remarkable in that the tank is attached directly to the equipment housing and is positioned above the lubrication unit so that the oil flows by gravity into the lubrication unit.

According to the invention, the tank is attached directly to the equipment housing of the lubrication unit. This characteristic eliminates the need for piping to connect the oil outlet of the tank to the oil inlet of the lubrication unit. Without such pipes, the radial or angular space around the casing between the tank and the lubrication unit is considerably reduced or eliminated, reducing the overall dimensions of the assembly. It is therefore possible to place the assembly formed by these two elements in a cramped engine compartment of the turbine engine, typically around the high-pressure compressor casing or the intermediate casing, which has a smaller diameter than the diameter of the fan casing and therefore less space available to accommodate the assembly.

Thanks to the invention, it is therefore possible to arrange the tank and the lubrication unit both in turbine engines with a non-ducted fan and in turbine engines with a ducted fan.

In addition, the number of interfaces is reduced, simplifying installation, maintenance and dismantling of the turbine engine. The weight of the assembly is also greatly reduced. The tank is also positioned above the lubrication unit. Thanks to this configuration, the oil flows by gravity to the lubrication unit, without forming air bubbles. The pump of the lubrication unit sucks in little or no air, which means that the lubrication circuit to which the lubrication unit is connected maintains adequate pressure.

The invention may comprise one or more of the following characteristics, taken alone or in combination with each other:
the tank extends angularly around the longitudinal axis between a first end located at an angular position between 12h and 2h and an opposite end located at an angular position between 3h and 4h;
the housing of the accessory gearbox extends angularly about the longitudinal axis between a first circumferential end located at an angular position of between 9h and 7h and a second circumferential end located at an angular position between 3h and 5h;
the housing comprises an upstream face and a downstream face extending between the first and second circumferential ends, the equipment housing being fitted and attached to the downstream face at the level of the second circumferential end;
radial suspension arms connecting the accessory gearbox to the casing;
connecting arms connecting the accessory gearbox to the tank;
a support arranged radially between the casing and the tank and extending over an angular sector around the casing, and
at least one connecting arm connecting the support to the casing, the support being attached to the tank and to the accessory gearbox;
the support is attached to the accessory gearbox by bolting;
the support has a first end attached to the tank and an opposite end attached at the level of the second circumferential end of the gearbox;
at least one connecting arm connecting the tank to the casing;
the tank is attached to the equipment housing by bolting;
the equipment housing is attached to the housing of the accessory gearbox by welding, bolting or flanges;
from upstream to downstream:
a fan, a low-pressure compressor,
a high-pressure compressor,
a high-pressure turbine mechanically connected to the high-pressure compressor, and
a low-pressure turbine mechanically connected to the low-pressure compressor, the casing being located around the high-pressure compressor or arranged axially between the low-pressure and high-pressure compressors.

### BRIEF DESCRIPTION OF THE FIGURES

Further characteristics and advantages will be apparent from the following description of non-limiting embodiments of the invention with reference to the accompanying drawings wherein:

FIG. 1 is a longitudinal sectional view of an example of an aircraft turbine engine according to the invention;

FIG. 2 is a schematic perspective view of the gas generator of the turbine engine in FIG. 1,

FIG. 3 is a schematic perspective view of an accessory gearbox equipping the turbine engine of the invention,

FIG. 4 is a schematic view of an oil circuit comprising a lubrication circuit and an oil recovery circuit,

FIG. 5 is a schematic perspective view of a lubrication unit equipping the turbine engine of the invention,

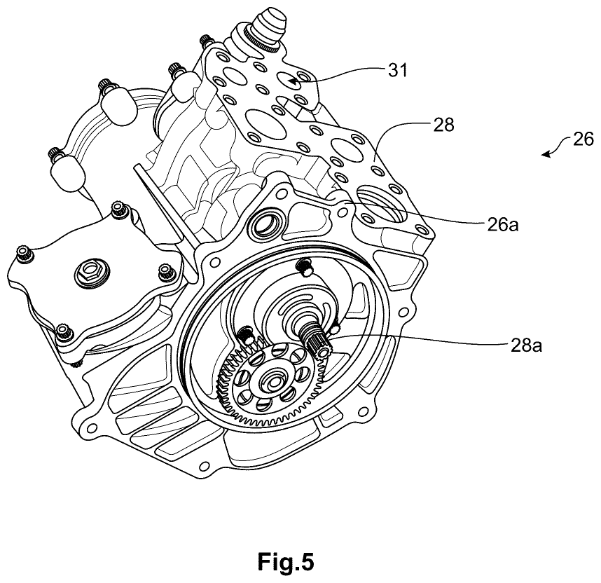

FIG. 6 is a schematic perspective view of an oil tank equipping the turbine engine of the invention,

FIG. 7 is a perspective view of a part of the turbine engine illustrating the attachment of the tank to the turbine engine according to a first embodiment of the invention,

FIG. 8 is a cross-sectional view of the turbine engine illustrating the attachment of the tank to the turbine engine according to a second embodiment of the invention,

FIG. 9 is a cross-sectional view of the turbine engine illustrating the attachment of the tank to the turbine engine according to a third embodiment of the invention.

### DETAILED DESCRIPTION OF THE INVENTION

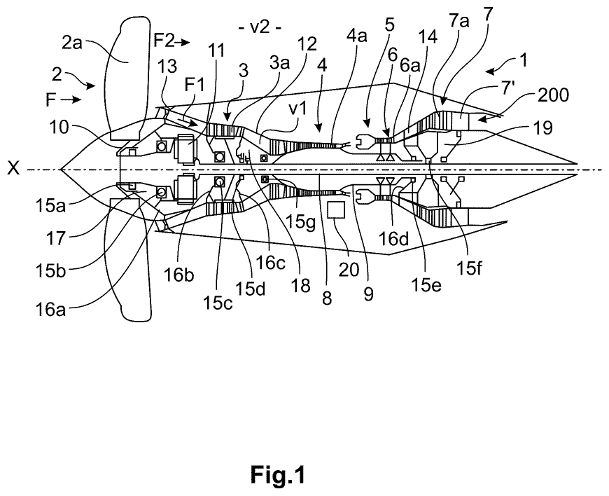

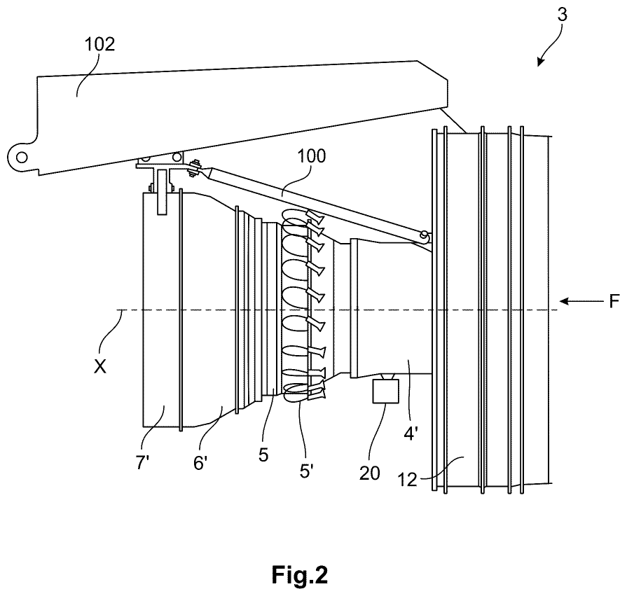

An example of an aircraft turbine engine 1 according to the invention is shown very briefly in FIGS. 1 and 2. The turbine engine 1 is, for example, a turbojet engine.

The turbine engine 1 extends along a longitudinal axis X. An air flow F flows through the turbine engine 1.

For the purposes of the present invention, the terms “upstream” and “downstream” are understood in relation to the direction of flow of the air flow F in the turbine engine 1 along the longitudinal axis X.

The terms “longitudinal” and “longitudinally” refer to the longitudinal axis X of the turbine engine 1. The terms “radial” and “radially” refer to a radial axis perpendicular to the longitudinal axis X. The terms “outside” and “inside” are understood in relation to the distance from the longitudinal axis X along the radial axis perpendicular to the longitudinal axis X.

The terms “bottom” and “top” refer to a nominal position of the turbine engine 1.

The angular positions expressed in hours are measured around the longitudinal axis X in the nominal position of the turbine engine 1, and are understood by analogy with the corresponding position of the hands on the dial of a clock when viewed from the front (upstream) of the turbine engine 1.

The nominal operating position of the turbine engine 1 is a position wherein the longitudinal axis X is perpendicular to the direction of gravity and wherein the turbine engine 1 is in the mounting position on the aircraft.

So, typically, in the nominal position, the wing of the aircraft is positioned at 12 o'clock.

The term “casing” is used in this invention to designate a stationary annular structural element of the turbine engine 1.

The turbine engine 1 comprises, from upstream to downstream, a fan 2 and a gas generator comprising a low-pressure compressor 3, a high-pressure compressor 4, a combustion chamber 5, a high-pressure turbine 6 and a low-pressure turbine 7.

Each compressor 3, 4 comprises a compressor rotor 3a, 4a and each turbine 6, 7 comprises a turbine rotor 6a, 7a. The compressor rotors 3a, 4a and turbine rotors 6a, 7a are made up of a plurality of stages, each comprising a bladed wheel.

The compressor rotor 3a of the low-pressure compressor 3 is connected to the turbine rotor 7a of the low-pressure turbine 7 by a low-pressure shaft 8. They form a low-pressure body.

The compressor rotor 4a of the high-pressure compressor 4 is connected to the turbine rotor 6a of the high-pressure turbine 6 by a high-pressure shaft 9. They form a high-pressure body.

The low-pressure shaft 8 and high-pressure shaft 9 are centered on the longitudinal axis X and movable in rotation about the longitudinal axis X. The high-pressure shaft 9 is arranged coaxially around the low-pressure shaft 8.

The air flow F passes through the fan 2 and divides into a primary air flow F1 passing through a primary duct v1 and a secondary air flow F2 passing through a secondary duct v2 surrounding the primary duct. The primary air flow F1 passes through the low-pressure compressor 3 and the high-pressure compressor 4. The compressed primary air flow F1 then passes through the combustion chamber 5, where it is mixed with a fuel that is injected into the combustion chamber 5 via supply injectors 5′. The gases produced by combustion pass through the high-pressure turbine 6 and the low-pressure turbine 7 and then escape through an exhaust casing 7′ and an exhaust nozzle 200. The energy in the gases is converted by the turbine rotors 6a and 7a of the high-pressure and low-pressure turbines 6 and 7 into mechanical energy to drive in rotation the high-pressure shafts 9 and low-pressure shafts 8 and, consequently, the high-pressure compressors 4 and low-pressure compressors 3.

The fan 2 comprises a disc that may rotate about the longitudinal axis X and moving vanes 2a evenly distributed over the disc. The fan 2 is preferably non-ducted. In contrast to a ducted fan 2, the fan 2 does not comprise a fan casing surrounding the vanes 2a. According to this example, the fan 2 may also comprise stationary vanes arranged downstream of the moving vanes 2a. Advantageously, these stationary vanes have a variable angle of pitch and are connected to a vane pitch control system comprising a hydraulic actuator such as a hydraulic cylinder.

In another example, not shown, the fan 2 is of the ducted type.

The disc of the fan 2 is driven in rotation by a fan shaft 10. Advantageously, the fan shaft 10 is connected to the low-pressure shaft 8, for example by means of a speed reducer 11. The speed reducer 11 is of mechanical type. For example, it may have an epicyclic or planetary train gear. Not illustrated, the speed reducer 11 typically comprises a sun gear and a ring gear centered on the longitudinal axis X. It also comprises planet gear meshing with the sun gear and the ring gear. It also comprises a planet carrier.

The sun gear is rotationally secured to the low-pressure shaft 8 and forms the input of the speed reducer 11, while one or other of the ring gear and the planet carrier, depending on the configuration of the speed reducer 11, is rotationally secured to the fan shaft 10 and forms the output of the speed reducer 11.

The speed reducer 11 allows the fan shaft 10 to be driven at a lower speed than the speed of rotation of the low-pressure shaft 8.

The turbine engine 1 also comprises at least one annular casing allowing to guide the primary and/or secondary air flows F1, F2 into the turbine engine 1 and, if necessary, to take up the forces exerted on the turbine engine 1. In particular, the turbine engine 1 comprises an annular inter-compressor casing 12 arranged axially between the low-pressure compressor 3 and the high-pressure compressor 4. The inter-compressor casing 12 comprises, for example, an inner shell and an outer shell which are centered on the longitudinal axis X. The inner and outer shells are connected by arms, for example.

The turbine engine 1 may also comprise an annular inlet casing 13. The inlet casing 13 is arranged axially between the fan 2 and the low-pressure compressor 3. The inlet casing 13 comprises, for example, an inner shell and an outer shell which are centered on the longitudinal axis X. The inner and outer shells are connected by arms, for example.

The turbine engine 1 may also comprise an annular inter-turbine casing 14. The inter-turbine casing 14 is arranged axially between the high-pressure turbine 6 and the low-pressure turbine 7.

The turbine engine 1 also comprises an annular compressor casing 4′ centered on the longitudinal axis X. The compressor casing 4′ is arranged around the rotor of the high-pressure compressor 4 and connected to the combustion chamber 5. The turbine engine 1 also comprises a turbine casing 6′ surrounding the high-pressure and low-pressure turbines 6, 7 and connected to the exhaust casing 7′.

The fan shaft 10 is guided in rotation by a first bearing 15a and advantageously a second bearing 15b. The first and second bearings 15a are arranged radially between the fan shaft 10 and the inlet casing 13. Each first and second bearing 15a, 15b comprises, for example, a rolling bearing arranged between an outer ring and an inner ring. The outer ring is carried by a first bearing support 16a extending radially inwards from the inlet casing 13. The inner ring is carried by the fan shaft 10. The rolling bearing is, for example, a row of balls. Advantageously, the rolling bearing comprises two rows of balls.

The low-pressure shaft 8 is guided in rotation by at least a third and fourth bearing 15c, 15d. The third bearing 15c is arranged radially between the inlet casing 13 and the low-pressure shaft 8. The third bearing 15c comprises a rolling bearing, for example a row of balls, arranged radially between an inner ring and an outer ring. The outer ring is carried by a second bearing support 16b connected to the inlet casing 13. The inner ring is carried by the low-pressure shaft 8. The fourth bearing 15d is arranged radially between the inter-compressor casing 12 and the low-pressure shaft 8. The fourth bearing 15d comprises a rolling bearing, for example a row of balls, arranged radially between an inner ring and an outer ring. The outer ring is carried by a third bearing support 16c connected to the inter-compressor casing 12. The inner ring is carried by the low-pressure shaft 8.

The high-pressure shaft 9 is guided in rotation by a fifth downstream bearing 15e and a fifth upstream bearing 15g. The fifth downstream bearing 15e, for example, is arranged radially between the high-pressure shaft 9 and the inter-turbine casing 14. The fifth downstream bearing 15e comprises a rolling bearing, for example a row of balls and a row of rollers arranged radially between an outer ring and an inner ring. The inner ring is carried by the high-pressure shaft 9 and the outer ring is carried by a fourth bearing support 16d connected to the inter-turbine casing 14. The fifth upstream bearing 15g is located, for example, between the high-pressure shaft 9 and the inter-compressor casing 12.

The low-pressure shaft 8 may be guided in rotation downstream by a sixth bearing 15f arranged radially between a downstream end of the low-pressure shaft 8 and the inter-turbine casing 14, for example.

The bearings 15a, 15b, 15c, 15d, 15e, 15f, 15g and the speed reducer 11 must be lubricated with oil to ensure they operate correctly. In order not to contaminate the associated members of the turbine engine 1 with oil, the bearings 15a, 15b, 15c, 15d, 15e, 15f, 15g and the speed reducer 11 are arranged in lubrication enclosures.

To this end, the turbine engine 1 also comprises at least one lubrication enclosure, in particular a first upstream enclosure 17 wherein the first, second and third bearings 15a, 15b, 15c and the speed reducer 11 are arranged, a second upstream lubrication enclosure 18 wherein the fourth bearing 15d and the fifth upstream bearing 15g are arranged and a downstream lubrication enclosure 19 wherein the fifth and sixth bearings 15e, 15f are arranged.

The upstream and downstream lubrication enclosures 17, 18 and 19 are annular. Each upstream and downstream lubrication enclosure 17, 18, 19 is delimited externally by a stationary part such as a casing and internally by a rotating part such as a shaft.

For example, the first upstream lubrication enclosure 17 is located in the inner shell of the inlet casing 13 and is delimited internally by the fan shaft 10. The second upstream lubrication enclosure 18 is located in the inner shell of the inter-compressor casing 12 and is delimited internally by the low-pressure shaft 8 and the downstream lubrication enclosure 18 is located in the inner shell of the inter-turbine casing 14 and is delimited internally by the high-pressure shaft 9.

The number of lubrication enclosures may vary depending on the configuration of the turbine engine 1. In the following, the upstream and downstream lubrication enclosures 17, 18 and 19 will be referred to interchangeably as “lubrication enclosures”.

With reference to FIG. 2, the turbine engine 1 also comprises at least one thrust connecting rod 100 to take up the axial forces generated by the fan 2. The thrust connecting rod 100 is connected upstream to the intermediate casing 12 and downstream to the exhaust casing 7′ by means of a pylon 102. The thrust connecting rod 100, for example, is connected to the inner shell of the intermediate casing 12. The thrust connecting rod 100 is therefore located around the compressor casing 4′, the combustion chamber 5 and the turbine casing 6′. The pylon 102 connects the turbine engine 1 to the aircraft.

The turbine engine 1 comprises an accessory gearbox 20 for mechanically driving equipment, also referred as accessories, of the turbine engine 1, by drawing mechanical power from one of the shafts 8, 9 of the turbine engine 1.

The gearbox 20, for example, is manufactured by additive manufacturing, by machining from solid or by investment casting.

The accessory gearbox 20 is advantageously located downstream of the fan 2 and outside one of the casings. Preferably, the accessory gearbox 20 is located outside the compressor casing 4′, i.e. around this casing. In another example, the accessory gearbox 20 may be located outside the inner shell of the intermediate casing 12. In the remainder of this description, the term “casing” will be used interchangeably to designate the compressor casing 4′ or the intermediate casing 12, in particular the inner shell of this intermediate casing 12.

According to the invention, the accessory gearbox 20 is suspended from the casing 4′, 12. Suspended means that the accessory gearbox 20 is connected to the casing 4′, 12 and is located at the lowest point of the turbine engine 1. The accessory gearbox 20 is therefore located below a horizontal plane P parallel to the longitudinal axis X and passing through the longitudinal axis X.

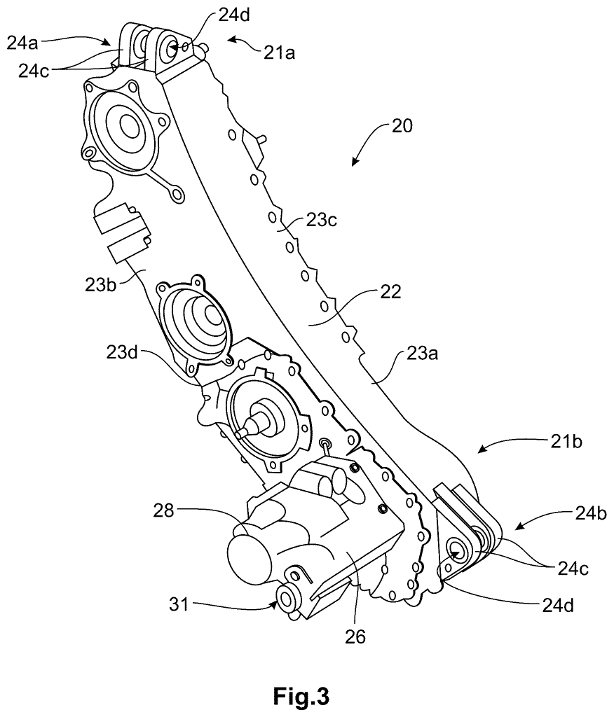

The accessory gearbox 20 (referred simply as the “gearbox”) is shown in FIG. 3, for example. It extends angularly around the longitudinal axis X between a first circumferential end 21a and a second circumferential end 21b. Preferably, the first circumferential end 21a is located at an angular position about the longitudinal axis X of between 9 and 7 o'clock and the second circumferential end 21b is located at an angular position about the longitudinal axis X of between 3 and 5 o'clock.

The gearbox 20 comprises a housing 22. The housing 22 extends from the first circumferential end 21a to the second circumferential end 21b. The housing 22 has an upstream face 23a and a downstream face 23b connected by an inner face 23c and an outer face 23d.

The gearbox 20 also comprises at least one clevis for suspension from the casing 4′, 12. A first clevis 24a is for example connected to the first circumferential end 21a and a second clevis 24b is for example connected to the second circumferential end 21b of the gearbox 20. Each clevis 24a, 24b preferably comprises two ears 24c, each with a bore 24d. For attaching the gearbox 20 to the casing 4′, 12, the turbine engine 1 also comprises suspension arms 25 extending radially from the gearbox 20 to the casing 4′, 12. The suspension arms 25 are, for example, received in the bores 24d and/or connected to the inner face 23b of the housing 22 of the gearbox 20. The suspension arms 25 are, for example, connecting rods. By providing flexible elements in the bores 24d, they allow the gearbox 20 to be connected flexibly to the casing 4′, 12 in order to allow movements of the gearbox 20. The turbine engine 1 may also comprise axially extending suspension arms to improve the attachment of the gearbox 20 to the casing 4′, 12.

The gearbox 20 further comprises an internal cavity (not visible) delimited by the housing 22 and a gear train arranged in the internal cavity.

The internal cavity is located in the housing 22 and extends substantially from the first circumferential end 21a to the second circumferential end 21b.

Not shown, the gear train comprises a series of intermeshing toothed wheels each mounted coaxially around a respective shaft. The toothed wheels of the gear train are driven by drawing mechanical power from the low-pressure or high-pressure shaft 8, 9 for example. The mechanical power taken is transferred to the gear train by means of a drive shaft coupled to one of the shafts in the gear train.

The gear train is also coupled to accessory rotors such as a Main Fuel Pump (MFP) and/or a Permanent Magnet Alternator (PMA) and/or an Air Turbine Starter (ATS). The gear train also drives a lubrication unit 26 of the turbine engine 1.

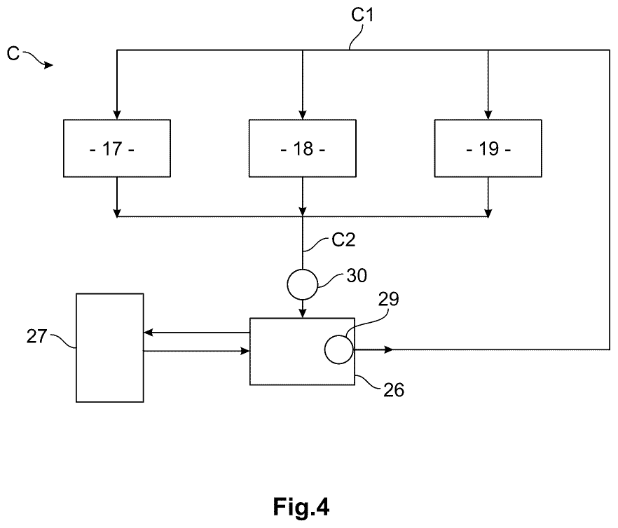

With reference to FIG. 4, the lubrication enclosures 17, 18 and 19 are supplied with oil by at least one oil circuit C from an oil tank 27. The oil circuit C of the turbine engine 1 is a closed circuit comprising an oil supply circuit C1 and possibly an oil recovery circuit C2, which are connected to the lubrication enclosures 17, 18, 19. The turbine engine 1 may also comprise a hydraulic control circuit connected to the control system for changing the pitch angle of the stationary vanes of the fan 2.

The lubrication unit 26 circulates oil in the supply and recovery circuits C1, C2, and possibly in the hydraulic control circuit.

The lubrication unit 26 comprises an equipment housing 28, at least one supply pump 29 and optionally a recovery pump 30.

With reference to FIG. 3, the equipment housing 28 is fitted and attached to the housing 22 of the gearbox 20. The equipment housing 28 is attached to the housing 22, for example, by welding, bolting or flanges 26a. Advantageously, the equipment housing 28 is attached to the downstream face 23b of the gearbox 20 at the level of the second circumferential end 24b of the gearbox 20. The lubrication unit 26 is therefore preferably located at an angular position around the longitudinal axis X of between 3h and 5h, in other words below the horizontal plane P.

The equipment housing 28 has an inner housing wherein the supply pump 29 is arranged. The supply pump 29 comprises a rotor arranged in the inner housing of the equipment housing 28 and coupled to the gear train of the gearbox 20 by means of a drive shaft 28a extending into the equipment housing 28 and around which the rotor of the supply pump 29 is mounted. The supply pump 29 allows oil to be sucked from the tank 27 and the oil sucked to be circulated in the supply circuit C1.

Depending on the requirements of the supply circuit C, the lubrication unit 26 may comprise a plurality of supply pumps 29, each rotor of which is located in the equipment housing 28.

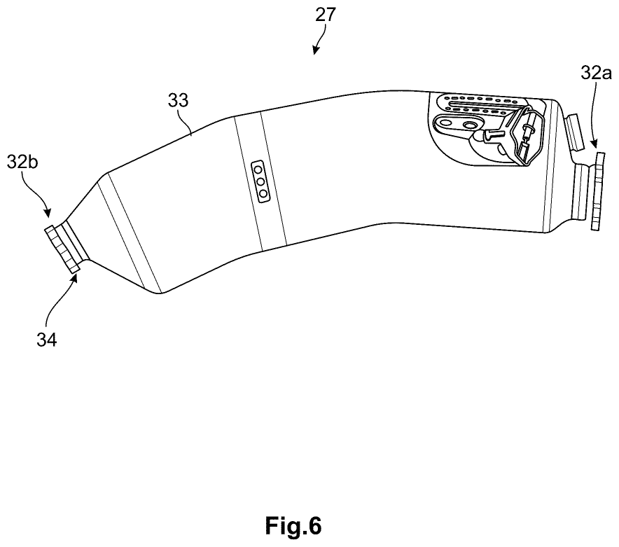

The lubrication unit 26 also comprises an oil inlet 31 connected to the supply pump 29 and connected to the tank 27. The oil inlet 31 is located on the equipment housing 28. With reference to FIG. 6, the tank 27 extends angularly around the longitudinal axis X between a first end 32a and an opposite end 32b. The tank 27 extends angularly around the longitudinal axis X between an angular position of between 12h and 2h and an angular position around the longitudinal axis X of between 3h and 4h. It is therefore understood that the first end 32a is located at an angular position between 12h and 2h and the opposite end 32b is located at an angular position between 3h and 4h.

According to the invention, the tank 27 is located above the lubrication unit 26. It is therefore located at an angular position closer to 12h than the angular position of the lubrication unit 26. The tank is therefore positioned above the horizontal plane P, in other words at the top of the turbine engine 1. The oil may therefore flow by gravity into the lubrication unit 26.

The tank 27 comprises an enclosure 33 extending between the ends 32a, 32b of the tank 27 and an oil outlet 34 formed in the enclosure 33 and preferably located at the opposite end 32b. The oil outlet 34 is connected to the oil inlet 31 of the lubrication unit 26 to supply the supply circuit C1 via the supply pump 29. Advantageously, the oil outlet 34 opens directly into the oil inlet 31 of the lubrication unit 26.

Advantageously and not illustrated, the enclosure 33 advantageously delimits a first oil compartment 0 g (zero gravitational force) and/or negative g (negative gravitational force) and a second oil compartment dedicated, for example, to lubricating the lubrication enclosures 17, 18, 19 under normal operating conditions of the turbine engine 1, i.e. under positive g conditions. The first compartment is preferably located in an internal (or low) position, while the second compartment is located in an external (or high) position.

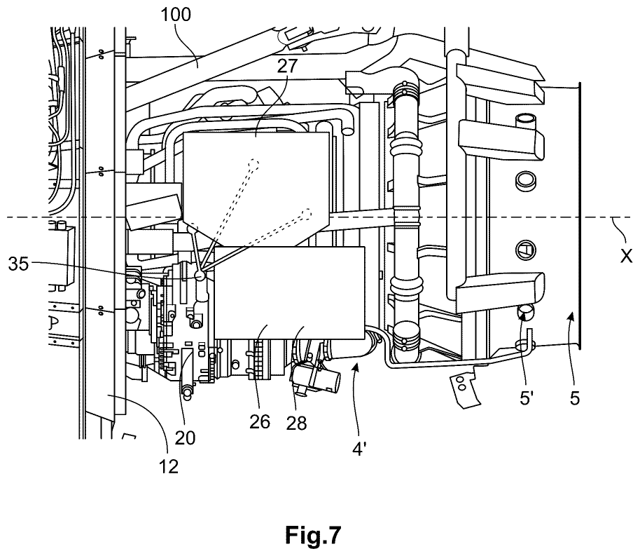

According to the invention, and as may be seen in FIGS. 7, 8 and 9, the tank 27 is located at an angular position closer to 12h than the angular position of the lubrication unit 26 and is therefore positioned above the lubrication unit 26. Thanks to this configuration, the oil may flow into the lubrication unit 26 by gravity. This prevents the formation of air bubbles in the tank 27 and the suction of these air bubbles by the supply pump 28, optimizing the pressure level in the oil circuit C and the hydraulic control circuit. The presence of air bubbles in the hydraulic control circuit may adversely affect the operation of the hydraulic actuator and prevent the proper pitch setting of the stationary vanes.

In addition, according to the invention, the tank 27 is directly attached to the equipment housing 28 of the lubrication unit 26. Preferably, the tank 27 is bolted to the equipment housing 28. For example, the opposite end 32b of the tank 27 has an attachment collar that rests on a basement of the equipment housing 28. Bolts connect the attachment collar to the basement. Alternatively, the tank 27 may be attached to the equipment housing 28 by any attachment means.

Thanks to the configuration of the invention wherein the tank 27 is directly mounted and attached to the equipment housing 28 of the lubrication unit 26, it is possible to dispense with pipes connecting the oil outlet 34 of the tank 27 to the oil inlet 31 of the lubrication unit 26. The overall dimension of the assembly formed by the tank 27 and the lubrication unit 26 therefore takes up very little space and may be easily installed in the engine compartment, in particular around the compressor casing 4′, even though its diameter is particularly small compared with the diameter of a fan casing. This means that this assembly may be installed in any type of turbine engine, particularly in the turbine engines with non-ducted fans that do not have large-diameter fan casings.

According to a first embodiment of the invention illustrated in FIG. 7, the turbine engine 1 also comprises connecting arms 35 connecting the gearbox 20 to the tank 27. The connecting arms 35 extend radially. They each comprise one end connected to the housing 22 of the gearbox 20, in particular to at least one of the inner faces 23c and/or downstream faces 23b, and an opposite end connected to the enclosure 33 of the tank 27 by welding or additive manufacturing, for example. The connecting arms 35 are, for example, connecting rods.

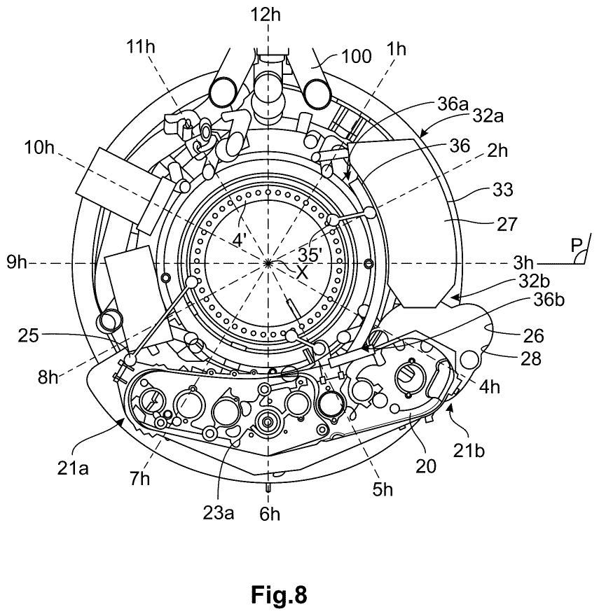

According to a second embodiment of the invention illustrated in FIG. 8, the turbine engine 1 also comprises a support 36 located radially between the casing 4′, 12 and the tank 27. The support 36 is attached to the tank 27 and the gearbox 20.

The support 36 extends angularly around the casing 4′, 12 between a first end 36a and an opposite end 36b. Preferably, the support 36 covers an angular sector equal to the angular sector over which the tank 27 extends. The support 36 thus carries the tank 27 over its entire circumferential height.

Advantageously, the support 36 is bolted to the gearbox 20. Preferably, the opposite end 36b is attached to the housing 22 of the gearbox 20, in particular to the downstream face 21b of the housing 22 and at the second circumferential end 21b of the gearbox 20. Alternatively, the support 36 may be connected to the gearbox 20 by any attachment means.

The first end 36a is attached to the tank 27, for example by welding, bolting or any other suitable attachment means. Attachment points may be provided along the entire height of the enclosure 33 of the tank 27 to improve the attachment of the support 36 to the tank 27.

In addition, in this embodiment, the support 36 is connected to the casing 4′, 12. To this end, in this embodiment, the turbine engine 1 comprises at least one connecting arm 35′ connecting the support 36 to the casing 4′, 12. The connecting arm 35′ extends radially from the support 36 to the casing 4′, 12. Advantageously, several radial connecting arms 35′ may connect the support 36 to the casing 4′, 12.

This embodiment allows the tank 27 to be attached even if the rigidity of the tank 27 is insufficient for it to be directly connected to the gearbox 20. Thanks to this solution for attaching the tank 27, its weight may be considerably reduced.

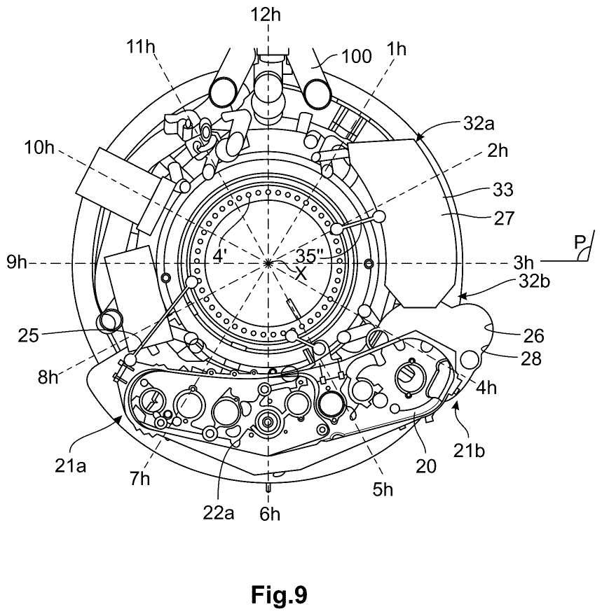

In a third embodiment illustrated in FIG. 9, the turbine engine 1 comprises at least one connecting arm 35″ connecting the tank 27 to the casing 4′, 12. The connecting arm 35″ extends radially between the tank 27 and the casing 4′, 12. By connecting the tank 27 directly to the casing 4′, 12, it is possible to reduce the forces exerted on the gearbox 20 and lighten the weight of the turbine engine 1 by doing away with the support 36.

1. A turbine engine for an aircraft, the turbine engine having a longitudinal axis and comprising:
an annular casing, centered on the longitudinal axis,
an accessory gearbox which is located outside the casing and which is suspended from the casing, the accessory gearbox being connected to the casing, and comprising:
a housing defining an internal cavity, and
a gear train arranged in the internal cavity,
a lubrication unit comprising:
an equipment housing fitted and attached to the housing of the accessory gearbox,
at least one pump located in the equipment housing and comprising a rotor coupled to the gear train, and
an oil inlet connected to the pump, and
an oil tank comprising an oil outlet connected to the oil inlet of the lubrication unit,
wherein the tank is attached directly to the equipment housing and is positioned above the lubrication unit so that the oil flows by gravity into the lubrication unit.

2. The turbine engine according to claim 1, wherein the tank extends angularly about the longitudinal axis between a first end located at an angular position between 12h and 2h and an opposite end located at an angular position between 3h and 4h.

3. The turbine engine according to claim 1, wherein the housing of the accessory gearbox extends angularly about the longitudinal axis between a first circumferential end located at an angular position of between 9h and 7h and a second circumferential end located at an angular position of between 3h and 5h.

4. The turbine engine according to claim 3, wherein the housing comprises an upstream face and a downstream face extending between the first and second circumferential end, the equipment housing being fitted and attached to the downstream face at the level of the second circumferential end.

5. The turbine engine according to claim 1, wherein it comprises radial suspension arms connecting the accessory gearbox to the casing,

6. The turbine engine according to claim 1, wherein it comprises connecting arms connecting the accessory gearbox to the tank.

7. The turbine engine according to claim 1, wherein it comprises:
a support arranged radially between the casing, and the tank and extending over an angular sector around the casing, and
at least one connecting arm connecting the support to the casing, the support being attached to the tank and to the accessory gearbox.

8. The turbine engine according to claim 7, wherein the support is attached to the accessory gearbox by bolting.

9. The turbine engine according to claim 7, wherein the housing of the accessory gearbox extends angularly about the longitudinal axis between a first circumferential end located at an angular position of between 9h and 7h and a second circumferential end located at an angular position of between 3h and 5h, and the housing comprises an upstream face and a downstream face extending between the first and second circumferential ends, the equipment housing being fitted and attached to the downstream face, at the level of the second circumferential end and the support has a first end attached to the tank and an opposite end attached at the level of the second circumferential end of the gearbox.

10. The turbine engine according to claim 1, wherein it comprises at least one connecting arm connecting the tank to the casing.

11. The turbine engine according to claim 1, wherein the tank is attached to the equipment housing by bolting.

12. The turbine engine according to claim 1, wherein the equipment housing is attached to the housing of the accessory gearbox by welding, bolting or flanges.

13. The turbine engine according to claim 1, wherein it comprises, from upstream to downstream:
a fan,
a low-pressure compressor,
a high-pressure compressor,
a high-pressure turbine mechanically connected to the high-pressure compressor and
a low-pressure turbine mechanically connected to the low-pressure compressor, the casing, being located around the high-pressure compressor or arranged axially between the low-pressure and high-pressure compressors.
